(19) United States
(12) Patent Application Publication
(10) Pub. No.: US 2005/0016014 A1
(43) Pub. Date: Jan. 27, 2005

(54) Dryer with a rotary drying drum

(76) Inventor: Jean-Marc Vandoorne-Feys, Wevelgem (BE)

Correspondence Address: WOOD, HERRON & EVANS, LLP, 2700 CAREW TOWER, 441 VINE STREET, CINCINNATI, OH, 45202, US

(21) Appl. No.: 10/620,536

(22) Filed: Jul. 16, 2003

(30) Foreign Application Priority Data
Jul. 17, 2002 (BE) 2002/0442

(51) Int. Cl. F26B 11/02

(52) U.S. Cl. 34/601

(57) ABSTRACT

A dryer with a rotary drying drum, in particular a dryer (1) for drying linen or the like, with a drive (7) which at least consists of an electric motor (8) coupled to the drying drum (2) in order to move the drying drum (2) in a rotating manner, wherein the above-mentioned electric motor (8) consists of a motor with at least ten poles.

### BACKROUND OF THE INVENTION

1. Field of the Invention

The present invention concerns a dryer with a rotary drying drum, in particular a dryer for drying linen or the like, with a drive which at least consists of an electric motor coupled to the drying drum in order to move the drying drum in a rotating manner.

2. Discussion of the Related Art

In the embodiments of such dryers known until now, use is made of the most conventional asynchronous electric motors for said drive, in other words electric motors having a limited number of electric poles and producing a relatively large engine speed, whereby this engine speed is then conventionally reduced via a multiple transmission to the usual rotational speed required for the drive of the drying drum.

### SUMMARY OF THE INVENTION

The present invention aims a dryer, in particular a drive for the drying drum of such a dryer, which dryer, drive respectively, has been improved in relation to the above-mentioned known embodiments in various aspects.

To this end, the invention concerns a dryer with a rotary drying drum, in particular a dryer for drying linen or the like, with a drive which at least consists of an electric motor coupled to the drying drum in order to move the drying drum in a rotating manner, characterized in that the aforesaid electric motor consists of a motor, in particular a motor which can be connected to the usual alternating current mains, with at least ten poles.

By using an electric motor having at least ten poles, in other words a large number of poles as opposed to the number of poles of the known motors which are traditionally used in dryers, is obtained that the applied electric motor according to the invention turns relatively slowly when it is connected to the usual alternating current mains, for example of 220 V or 380 V and 50 Hz, which offers the advantage that the above-mentioned transmission is less heavily loaded, less subject to wear and moreover, at least according to a preferred embodiment, that the usual multiple transmission can be replaced by a simpler embodiment, which results in a considerable space saving in the housing of the dryer, as less parts are required for the transmission, and also less bearings have to be built in, for example for intermediate shafts.

The aforesaid electric motor preferably even has more than 10 poles, for example 12, 14, 16, 20 or 22 poles, making the above-mentioned advantages even more obvious. According to the most preferred embodiment, however, it will have 18 poles, as an optimal compromise is obtained with this number of poles between the aimed effect of the invention on the one hand and its practical embodiment on the other hand. A number of poles which is too large is disadvantageous in that the motor itself becomes too large.

Since, as mentioned above, it is now possible to couple the drying drum to the shaft of the electric motor via just a single transmission, such a single transmission will preferably be applied. Although the transmission ratio of this transmission may be of any nature whatsoever, it will preferably have a transmission ratio providing for a reduction, in particular in such a way that the drying drum has a lower rotational speed than the shaft of the above-mentioned electric motor. Thus, it is possible to realize an optimal transmission between the electric motor and the drying drum with a minimum number of parts thanks to the combination of characteristics, namely that just a single transmission is applied on the one hand, and that an electric motor with at least 10 poles is used on the other hand.

In a practical embodiment, use is made of an endless transmission element for the transmission, such as a belt or the like, which provides for a direct transmission of the motor shaft to the drying drum.

In practice, the transmission ratio of the transmission will be selected such that the rotational speed of the drying drum amounts to less then 50 revolutions per minute. Initially, by an electric motor is meant an asynchronous motor, but variants are not excluded.

It should be noted that the use of just a single transmission naturally also offers the advantages linked thereto, even when another motor than a motor with at least ten poles is used. According to a second aspect of the invention, it also concerns a dryer with a rotary drying drum, in particular a dryer for drying linen or the like, with a drive which at least consists of an electric motor coupled to the drying drum in order to move the drying drum in a rotating manner, characterized in that the drying drum is coupled to the shaft of the electric motor via a single transmission and in that the electric motor is embodied such that, via this single transmission, is obtained a rotational speed in the drying drum of the usual order of magnitude, in particular a rotational speed of less than 100 revolutions per minute, better still less than 50 revolutions per minute.

### BRIEF DESCRIPTION OF THE DRAWINGS

In order to better explain the characteristics of the invention, the following preferred embodiment is described as an example only without being limitative in any way, with reference to the sole accompanying drawing which schematically represents a dryer according to the invention.

### DESCRIPTION OF THE PREFERED EMBODIMENT

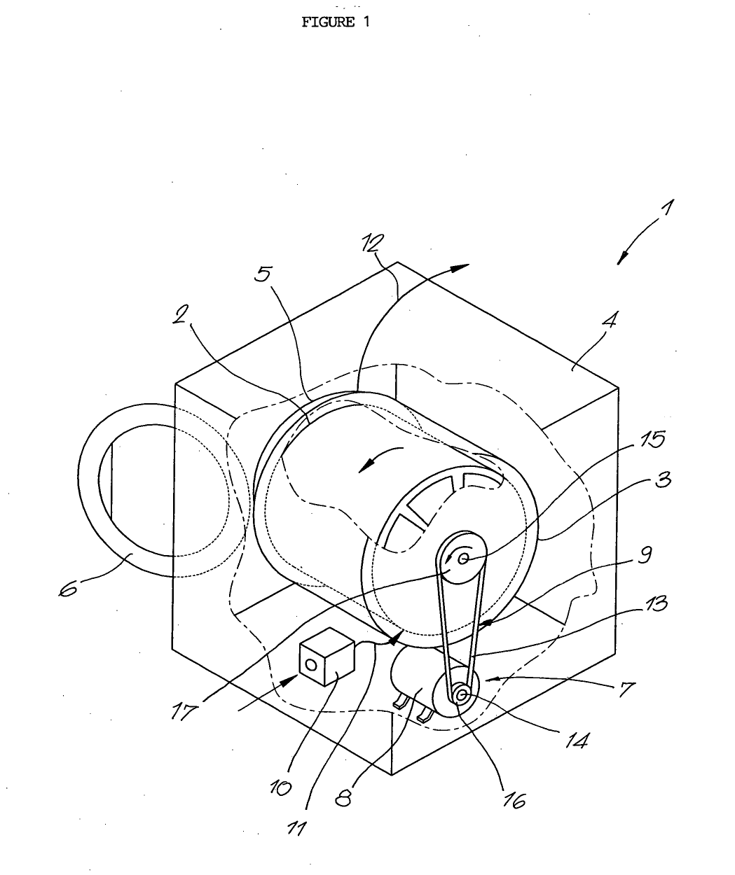

As is represented in FIG. 1 in a strongly schematic manner, the invention concerns a dryer 1 with a rotary drying drum 2.

In the given example, this rotary drying drum 2 is provided in a fixed outer drum 3 which has in turn been built in in the housing 4 of the drying drum 1.

In the drying drum 2 can be put linen or the like, can be removed from it respectively, via an access opening 5 which can be sealed by means of a door 6.

The drying drum 2 can be driven in a rotating manner, for example in a single direction of rotation or alternately in both directions of rotation, by means of a drive 7 which at least consists of an electric motor 8 which is coupled to the drying drum 2 by means of a transmission 9.

Further, the drying drum 1 is equipped with air suction means and heating means 10 with which can be created a hot air flow within the space of the drying drum 2 via a supply pipe 11 and a discharge pipe 12 which are merely represented schematically. Naturally, other ways of air treatment are possible according to variants, for example via a closed circuit, whereby the moisture which has been removed from the linen condenses and is collected.

The invention is special in that the above-mentioned electric motor 8 has at least ten poles, and preferably eighteen poles, which results in the advantages as mentioned in the introduction. Preference is hereby given to an asynchronous motor 8.

Exactly how an asynchronous motor 8 with a specific number of poles should be realized is known as such, and the construction of such a motor is within the reach of any professional. For clarity's sake is further mentioned that by a ten-poled motor should be understood a motor whereby, at the perimeter of the air slot between the rotor and stator, there are five areas with incoming flux and five areas with outgoing flux. In case of several poles, the argumentation is analogous.

Another special characteristic of the invention consists in that the transmission 9 is formed of a simple transmission, in particular a transmission making use of an endless transmission element, namely a belt 13, which provides for a direct transmission from the motor shaft 14 to the dryer drum shaft 15, in other words the shaft of the dryer drum 2, by means of pulleys 16 and 17 respectively provided upon it.

As represented in FIG. 1, the transmission 9 provides for a reduction of the rotational speed as the pulley 16 has a smaller diameter than the pulley 17.

It is clear that a particularly simple construction is obtained in this manner, which is moreover little liable to wear and which also saves space in the housing 4, so that the whole can either be made smaller, or so that more space becomes available for other parts, for example for a larger drying drum 2 or also for extending the peripherals, by which is meant for example the air suction means and heating means 10.

The invention is by no means limited to the above-described embodiment given as an example and represented in the accompanying drawings; on the contrary, such a dryer can be made in different shapes and dimensions while still remaining within the scope of the invention.

1. A dryer with a rotary drying drum, in particular a dryer for drying linen or the like, with a drive which at least consists of an electric motor coupled to the drying drum in order to move the drying drum in a rotating manner, wherein the above-mentioned electric motor consists of a motor with at least ten poles.

2. The dryer according to claim 1, wherein the above-mentioned electric motor has 12, 14, 16, 20 or 22 poles.

3. The dryer according to claim 1, wherein the above-mentioned electric motor has eighteen poles.

4. The dryer according to claim 1, wherein the drying drum is coupled to the shaft of the electric motor via a single transmission.

5. The dryer according to claim 4, wherein the above-mentioned transmission has a transmission ratio providing for a reduction, in particular such that the dryer has a lower rotational speed than the shaft of the above-mentioned electric motor.

6. The dryer according to claim 4, wherein the transmission makes use of an endless transmission element, such as a belt or the like, which provides for a direct transmission of the motor shaft to the drying drum shaft.

7. The dryer according to claims 4, wherein the above-mentioned electric motor consists of an asynchronous motor.

8. The dryer according to claim 1, wherein the rotational speed of the dryer drum amounts to less than 50 revolutions per minute.

9. A dryer with a rotary drying drum, in particular a dryer for drying linen or the like, with a drive which at least consists of an electric motor coupled to the drying drum in order to move the drying drum in a rotating manner, wherein the drying drum is coupled to the shaft of the electric motor via a single transmission and wherein the electric motor is embodied such that, via this single transmission, is obtained a rotational speed in the drying drum of the usual order of magnitude, in particular a rotational speed of less than 100 revolutions per minute, better still less than 50 revolutions per minute.
